(19) United States
(12) Patent Application Publication
(10) Pub. No.: US 2017/0219391 A1
(43) Pub. Date: Aug. 3, 2017

(54) Pneumatic Sensor and Electronic Cigarette

(71) Applicant: Nazhiyuan Technology (Tangshan), LLC., Tangshan (CN)

(72) Inventors: Tongfu Lin, Tangshan (CN); Lijia Sun, Tangshan (CN); Haifeng Diao, Tangshan (CN); Qiang Zhong, Tangshan (CN); Hao Zhao, Tangshan (CN); Charles Hsu, Tangshan (CN); Xiaoya Sun, Tangshan (CN); Chi Cheng, Tangshan (CN); Ying Zhao, Tangshan (CN); Xiao Qiu, Tangshan (CN); Lixing Hao, Tangshan (CN)

(73) Assignee: Nazhiyuan Technology (Tangshan), LLC.

(21) Appl. No.: 15/325,302

(22) PCT Filed: Jun. 12, 2016
(86) PCT No.: PCT/CN2016/085450

§ 371 Date: Apr. 18, 2017

(30) Foreign Application Priority Data
Jul. 28, 2015 (CN) 2015104504740
Aug. 27, 2015 (CN) 201520654128X
Oct. 21, 2015 (CN) 2015208195188

(51) Int. Cl. G01D 5/42; H02N 1/04; A24F 47/00

(52) U.S. Cl. CPC G01D 5/42; A24F 47/008; H02N 1/04

(57) ABSTRACT

The present invention discloses a pneumatic sensor, having an air intake and an air outlet. The pneumatic sensor includes a first triboelectric component, a shell, a second triboelectric component and a third triboelectric component, wherein the shell has a hollow structure in a preset shape to form an airflow channel, and the airflow channel is communicated with the air intake and the air outlet, thus allowing the airflow to enter the airflow channel from the air intake and flow out from the air outlet; the first triboelectric component is arranged in the airflow channel, and the second and the third triboelectric components are arranged at positions capable of contacting with the first triboelectric component; and the second and the third triboelectric components include electric signal output terminals of the pneumatic sensor.

### CROSS RFERENCE TO RELATED APPLICATIONS

The present application claims the priority of Chinese patent application No. 201510450474.0 filed with the Chinese Patent Office on Jul. 28, 2015 and entitled “PNEUMATIC SENSOR”, Chinese patent application No. 201520654128.X filed with the Chinese Patent Office on Aug. 27, 2015 and entitled “TOTALLY ENCLOSED TRIBOELECTRIC GENERATOR AND PNEUMATIC SENSOR”, and Chinese patent application No. 201520819518.8 filed with the Chinese Patent Office on Oct. 21, 2015 and entitled “SIGNAL PROCESSING SYSTEM AND ELECTRONIC CIGARETTE USING THE SAME”, the entire contents of which are herein incorporated by reference.

### FIELD OF THE INVENTION

The present invention relates to the technical field of sensors, and particularly relates to a pneumatic sensor and an electronic cigarette using the pneumatic sensor.

### BACKGROUND OF THE INVENTION

With the continuous development of science and technology and the living demands of people, sensors based on various working principles have been developed, such as pressure sensors, temperature sensors and pneumatic sensors, etc. These sensors have been used in all aspects of life and scientific research. For example, the pneumatic sensors are applied to electronic cigarettes.

The pneumatic sensor generates an electrical signal by airflow. In the prior art, the atomizer, the pneumatic sensor and the controller of the electronic cigarette are all arranged in a smoke channel. A user inhales at the smoking end of the electronic cigarette to drive the air in the smoke channel to flow, therefore the pneumatic sensor senses the airflow signal and triggers the controller to control a battery component to supply power to the atomizer, and the atomizer atomizes tobacco tar to smoke, which is inhaled by the user via the smoke channel However, the existing pneumatic sensors have the following defects, such as complex manufacturing process, poor sensitivity, poor stability and prone to false triggering due to external vibration.

### SUMMARY OF THE INVENTION

The objective of the present invention is to provide a pneumatic sensor in view of the defects in the prior art, in order to simplify the manufacturing process of the existing pneumatic sensors and improve the driving force of airflow on a first triboelectric component in the pneumatic sensor, and further to improve the sensitivity and stability of the pneumatic sensor.

The present invention provides a pneumatic sensor, having an air intake and an air outlet. The pneumatic sensor includes a first triboelectric component, a shell, a second triboelectric component and a third triboelectric component; wherein, the shell has a hollow structure in a preset shape to form an airflow channel, and the airflow channel is communicated with the air intake and the air outlet, thus allowing the airflow to enter the airflow channel from the air intake and flow out from the air outlet; the first triboelectric component is arranged in the airflow channel, and the second triboelectric component and the third triboelectric component are arranged at positions capable of contacting with the first triboelectric component; and when the airflow enters the airflow channel from the air intake, the first triboelectric component respectively forms friction with the second triboelectric component and/or the third triboelectric component due to the airflow effect, thereby generating electric signals, and the second triboelectric component and the third triboelectric component include electric signal output terminals of the pneumatic sensor.

In addition, the first triboelectric component, the second triboelectric component and the third triboelectric component constitute a totally enclosed triboelectric generator; the second triboelectric component and the third triboelectric component are jointly configured as vibrating film which surrounds to form an enclosed hollow cavity, and the first triboelectric component is configured as a fixed film located in the enclosed hollow cavity; the vibrating film forms contact friction with the fixed film under the action of an external force to form a triboelectric interface; the vibrating film and/or the fixed film is provided with a first electrode layer and/or a second electrode layer; and the first electrode layer and/or the second electrode layer serve(s) as an output terminal of the totally enclosed triboelectric generator.

In addition, the pneumatic sensor can further include a signal processing system, and the signal processing system includes: a signal preprocessing module connected with the electric signal output terminal of the pneumatic sensor and a signal control module connected with the signal preprocessing module; the signal preprocessing module is used for collecting an output signal of the pneumatic sensor and acquiring a flag bit signal according to a comparative result between the output signal and a preset threshold; and the signal control module is used for receiving the flag bit signal output by the signal preprocessing module and analyzing and processing the flag bit signal to acquire a trigger working signal.

The present invention further provides an electronic cigarette, including the aforementioned pneumatic sensor.

The airflow channel is formed in the shell of the aforementioned pneumatic sensor provided by the present invention, the first triboelectric component is arranged in the airflow channel, and when the airflow enters the airflow channel from the air intake, the first triboelectric component forms friction with the second triboelectric component and/or the third triboelectric component due to the airflow effect, thereby generating electric signals. The aforementioned pneumatic sensor provided by the present invention simplifies the manufacturing process of the pneumatic sensors, and improves the driving force of the airflow on the first triboelectric component in the pneumatic sensor, thereby improving the vibration frequency of the first triboelectric component, and further the output voltage, the sensitivity and stability of the pneumatic sensor are effectively improved.

In addition, according to the aforementioned pneumatic sensor provided by the present invention, wherein the vibrating film surrounds the enclosed hollow cavity, the fixed film is located inside the enclosed hollow cavity, and the vibrating film forms contact friction with the fixed film under the action of the external force to form a triboelectric interface; and signals are output by the electrode layers formed on the vibrating film and/or the fixed film. In the triboelectric generator of the aforementioned pneumatic sensor provided by the present invention, traditional package component is omitted, and the interference from external environment (e.g., humidity) is prevented owing to its own structure, therefore the manufacturing process is simple, and the cost is also saved.

In addition, according to the aforementioned pneumatic sensor provided by the present invention, the signal processing system therein collects, analyzes and processes the tiny signal output by the pneumatic sensor, so that the output trigger working signal is more accurate and stable.

### BRIEF DESCRIPTION OF THE DRAWINGS

By reading the detailed description of preferred embodiments below, a variety of other advantages and benefits will become clear to those of ordinary skills in the art. The accompanying drawings are only for the purpose of showing the preferred embodiments, and are not deemed as limitations to the present invention. In all accompanying drawings, identical reference signs represent identical components. In the accompanying drawings:

FIG. 1 is a schematic diagram of a three-dimensional structure of embodiment one of a pneumatic sensor provided by the present invention;

FIG. 2 is a schematic diagram of a three-dimensional structure of a shell of embodiment one of the pneumatic sensor provided by the present invention;

FIG. 3 is a schematic diagram of a three-dimensional structure of a triboelectric component of embodiment one of the pneumatic sensor provided by the present invention;

FIG. 4 is a schematic diagram of a three-dimensional structure of a shell of embodiment two of the pneumatic sensor provided by the present invention;

FIG. 5 is a schematic diagram of a three-dimensional structure of a shell of embodiment three of the pneumatic sensor provided by the present invention;

FIG. 6a is a schematic diagram of a three-dimensional structure of a shell of embodiment four of the pneumatic sensor provided by the present invention;

FIG. 6b is a schematic diagram of a cross section of a hollow structure of the shell of embodiment four of the pneumatic sensor provided by the present invention;

FIG. 7a is a schematic diagram of a three-dimensional structure of a shell of embodiment five of the pneumatic sensor provided by the present invention;

FIG. 7b is a schematic diagram of a cross section of a hollow structure of the shell of embodiment five of the pneumatic sensor provided by the present invention;

FIG. 8 is a schematic diagram of a three-dimensional structure of embodiment six of the pneumatic sensor provided by the present invention;

FIG. 9a is a top view of the shell of embodiment six of the pneumatic sensor provided by the present invention;

FIG. 9b is an A-A sectional view of the shell of embodiment six of the pneumatic sensor provided by the present invention;

FIG. 9c is another A-A sectional view of the shell of embodiment six of the pneumatic sensor provided by the present invention;

FIG. 10 is a schematic diagram of a three-dimensional structure after the shell and the triboelectric component are combined in embodiment six of the pneumatic sensor provided by the present invention;

FIG. 11 is a schematic diagram of a three-dimensional structure of a shell of embodiment seven of the pneumatic sensor provided by the present invention;

FIG. 12 is a schematic diagram of a three-dimensional structure of a shell of embodiment eight of the pneumatic sensor provided by the present invention;

FIG. 13 is a schematic diagram of a three-dimensional structure of a shell of embodiment nine of the pneumatic sensor provided by the present invention;

FIG. 14 is a schematic diagram of a three-dimensional structure of a shell of embodiment ten of the pneumatic sensor provided by the present invention;

FIG. 15 is a schematic diagram of another structure of the triboelectric component provided by the present invention;

FIG. 16 is a test chart of vibration frequency of a triboelectric component of embodiment six of the pneumatic sensor provided by the present invention;

FIG. 17 is a test chart of the vibration frequency of a triboelectric component of a pneumatic sensor arranged with no airflow channel provided by the present invention;

FIG. 18 is a test chart of vibration frequency of a triboelectric component of embodiment seven of the pneumatic sensor provided by the present invention;

FIG. 19 is a test chart of vibration frequency of a triboelectric component of embodiment eight of the pneumatic sensor provided by the present invention;

FIG. 20 shows a schematic diagram of a totally enclosed triboelectric generator included in the pneumatic sensor provided by the present invention;

FIG. 21 shows a schematic diagram of another embodiment of the totally enclosed triboelectric generator included in the pneumatic sensor provided by the present invention;

FIG. 22 shows a schematic diagram of yet another embodiment of the totally enclosed triboelectric generator included in the pneumatic sensor provided by the present invention;

FIG. 23 shows a schematic diagram of yet another embodiment of the totally enclosed triboelectric generator included in the pneumatic sensor provided by the present invention;

FIG. 24 shows a functional block diagram of an embodiment of a signal processing system included in the pneumatic sensor provided by the present invention.

### PREFERRED EMBODIMENTS OF THE PRESENT INVENTION

To fully understand the objectives, features and effects of the present invention, the present invention will be described in detail by the following specific embodiments, but the present invention is not merely limited thereto.

A pneumatic sensor provided by the present invention has an air intake and an air outlet. The pneumatic sensor includes a first triboelectric component, a shell, a second triboelectric component and a third triboelectric component. The shell has a hollow structure in a preset shape to form an airflow channel, and the airflow channel is communicated with the air intake and the air outlet, thus allowing the airflow to enter the airflow channel from the air intake and flow out from the air outlet. The first triboelectric component is arranged in the airflow channel, and the second triboelectric component and the third triboelectric component are arranged at positions capable of contacting with the first triboelectric component. When the airflow enters the airflow channel from the air intake, the first triboelectric component respectively forms friction with the second triboelectric component and/or the third triboelectric component due to the airflow effect, thereby generating electric signals, and the second triboelectric component and the third triboelectric component include electric signal output terminals of the pneumatic sensor.

The hollow structure is provided with an upper opening at the top of the shell and a lower opening at the bottom of the shell. The present invention mainly provides two ways for arranging the air intake and the air outlet. In the first arrangement way, the second triboelectric component partially covers the upper opening to form the air intake, and the third triboelectric component partially covers the lower opening to form the air outlet; while in the second arrangement way, the air intake is formed in a first area where an outer wall and the top of the shell intersect, and the air outlet is formed in a second area where the outer wall and the bottom of the shell intersect, in this case, preferably, the second triboelectric component partially covers the upper opening and does not cover the air intake; and the third triboelectric component partially covers the lower opening and does not cover the air outlet, so that more airflow can flow in and flow out from the pneumatic sensor within a unit time. In addition, in the second arrangement way, the second triboelectric component can also completely cover the upper opening, and the third triboelectric component can also completely cover the lower opening.

To better protect the pneumatic sensor and reduce interference from the outside to the pneumatic sensor, the pneumatic sensor can further include an upper cover body located at the top of the shell and a lower cover body located at the bottom of the shell. The upper cover body covers the second triboelectric component, and the lower cover body covers the third triboelectric component. The upper cover body and the lower cover body can also play the role of shielding.

The first triboelectric component, the second triboelectric component and the third triboelectric component constitute at least one triboelectric generator, wherein the triboelectric generator is of a three-layer structure, a four-layer structure, a five-layer structure or an intermediate electrode structure, the triboelectric generator at least includes two opposite surfaces constituting a triboelectric interface, and the triboelectric generator has at least two output terminals. A micro-nano structure is arranged on at least one of the two opposite surfaces constituting the triboelectric interface. With respect to the specific structure of the at least one triboelectric generator constituted by the first triboelectric component, the second triboelectric component and the third triboelectric component, detailed description will be given in the subsequent embodiments.

The structure and the working principle of the pneumatic sensor provided by the present invention will be further described below by specific embodiments.

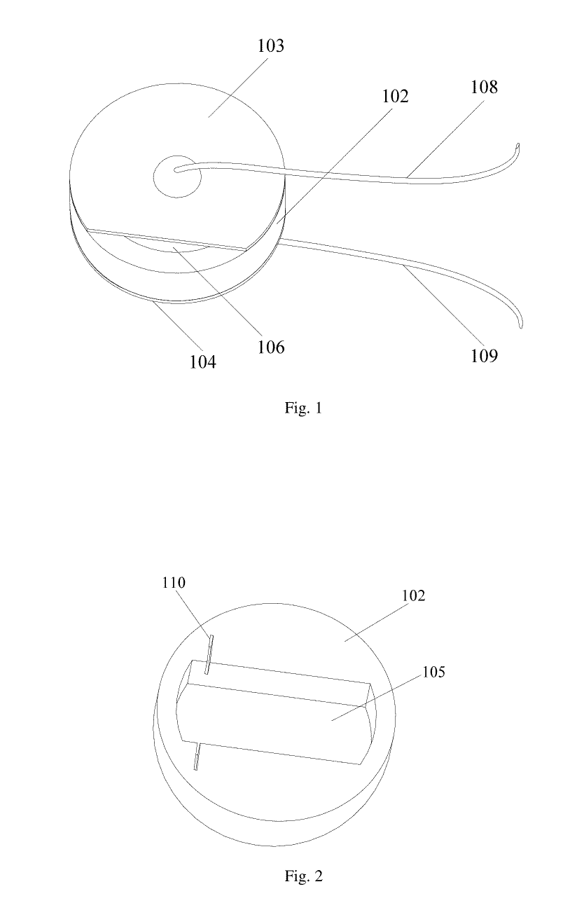

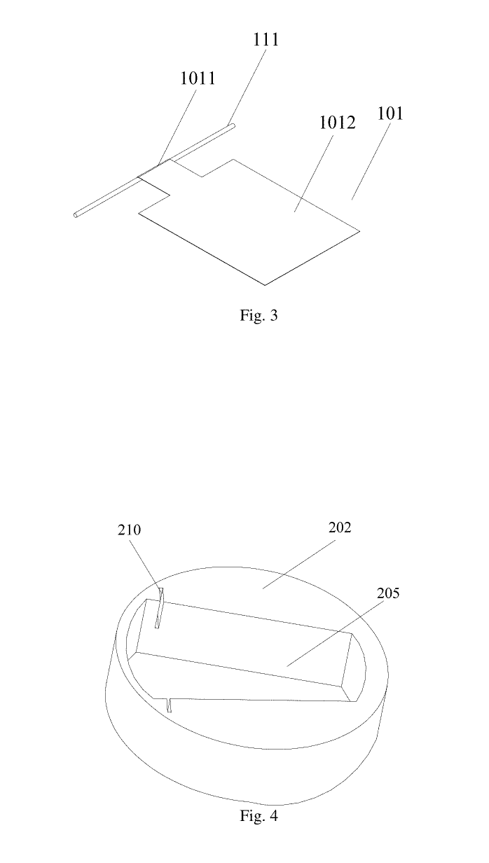

FIG. 1 is a schematic diagram of a three-dimensional structure of embodiment one of a pneumatic sensor provided by the present invention, FIG. 2 is a schematic diagram of a three-dimensional structure of a shell of embodiment one of the pneumatic sensor provided by the present invention, and FIG. 3 is a schematic diagram of a three-dimensional structure of a triboelectric component of embodiment one of the pneumatic sensor provided by the present invention. As shown in FIG. 1 to FIG. 3, the pneumatic sensor includes: a first triboelectric component 101, a shell 102, a first electrode 103 (i.e., a second triboelectric component) and a second electrode 104 (i.e., a third triboelectric component). The shell 102 is of a hollow structure in a preset shape to form an airflow channel 105. The hollow structure is provided with an upper opening at the top of the shell 102 and a lower opening at the bottom of the shell 102, the first electrode 103 partially covers the upper opening to form an air intake 106, the second electrode 104 partially covers the lower opening to form an air outlet (not shown in the figures), and the air intake 106 and the air outlet are formed oppositely. The airflow channel 105 is communicated with the air intake 106 and the air outlet, thus allowing the airflow to enter the airflow channel 105 from the air intake 106 and flow out from the air outlet. In the embodiment, the cross section of the hollow structure is of a structure shaped like “—”, and the air intake 106 and the air outlet are respectively located at the top of one end and the bottom of another end of the hollow structure, the longitudinal sectional area of the side of the hollow structure close to the air intake 106 is equal to the longitudinal sectional area of the side of the hollow structure close to the air outlet, and since the air intake 106 and the air outlet are formed oppositely, it is conducive to improving the driving force of the airflow on the first triboelectric component 101.

The first triboelectric component 101 is arranged in the airflow channel 105. As the first electrode 103 and the second electrode 104 partially cover the upper opening at the top and the lower opening at the bottom of the shell 102 respectively, when the airflow enters the airflow channel 105 from the air intake 106, the first triboelectric component 101 respectively forms friction with the first electrode 103 and/or the second electrode 104 due to the airflow effect, thereby generating electric signals, and the first electrode 103 and the second electrode 104 are electric signal output terminals of the pneumatic sensor.

As shown in FIG. 1, the first electrode 103 and the second electrode 104 are respectively led out by a lead wire 108 and a lead wire 109, this arrangement is conducive to processing the electric signal generated by the pneumatic sensor subsequently. Of course, those skilled in the art can also use no lead wire, and this is not limited herein.

In combination with FIG. 2 and FIG. 3, the first triboelectric component 101 is provided with a fixed part 1011 and a triboelectric part 1012. The fixed part 1011 of the first triboelectric component 101 is fixedly connected with the shell 102, and the triboelectric part 1012 of the first triboelectric component 101 forms friction with the first electrode 103 and/or the second electrode 104 respectively. The first triboelectric component 101 can be fixedly connected with the shell 102 in a variety of ways, those skilled in the art can set according to actual demands, and this is not specifically defined herein in the present invention. In the embodiment, in order to fixedly connect the first triboelectric component 101 with the shell 102, the pneumatic sensor further includes a fastener 111, and a groove 110 is formed in the shell 102. The fastener 111 is embedded into the groove 110 after being fixedly connected with the fixed part 1011 of the first triboelectric component 101, so as to fixedly connect the first triboelectric component 101 with the shell 102 and make the flow direction of the airflow in the airflow channel 105 be parallel to the plane in which the first triboelectric component 101 is located. This arrangement improves the driving force of the airflow on the first triboelectric component 101, thereby improving the vibration frequency of the first triboelectric component 101, and further the output voltage and sensitivity of the pneumatic sensor are effectively improved.

The first triboelectric component 101 in the embodiment includes a first high molecular polymer layer. In this case, two opposite surfaces of the first high molecular polymer layer and the first electrode 103 and two opposite surfaces of the first high molecular polymer layer and the second electrode 104 respectively constitutes triboelectric interfaces. When the airflow enters the airflow channel 105 from the air intake 106, the first high molecular polymer layer respectively forms friction with the first electrode 103 and/or the second electrode 104 under the airflow effect, thereby generating electric signals, therefore the first high molecular polymer layer (i.e., the first triboelectric component 101), the first electrode 103 (i.e., the second triboelectric component) and the second electrode 104 (i.e., the third triboelectric component) constitute a triboelectric generator having a three-layer structure together.

In order to enhance the effect of power generation through friction, a micro-nano structure (not shown in the figures) is arranged on at least one of the two opposite surfaces in the triboelectric interfaces which are constituted by the first high molecular polymer layer with the first electrode 103 and the second electrode 104 respectively, so as to generate more inductive charges on the first electrode 103 and/or the second electrode 104.

In addition, the pneumatic sensor can further include an upper cover body (not shown in the figures) located at the top of the shell 102 and a lower cover body (not shown in the figures) located at the bottom of the shell 102. The upper cover body covers the first electrode 103, and the lower cover body covers the second electrode 104. The upper cover body and the lower cover body play a role of shielding the external interference and protecting the internal structure of the pneumatic sensor.

FIG. 4 is a schematic diagram of a three-dimensional structure of a shell of embodiment two of the pneumatic sensor provided by the present invention. As shown in FIG. 4, the difference between the pneumatic sensor in embodiment two and the pneumatic sensor in embodiment one lies in that the longitudinal sectional area of the side of the hollow structure close to the air intake is greater than the longitudinal sectional area of the side of the hollow structure close to the air outlet. A groove 210 is formed in one end close to the air intake of a shell 202, and the fastener (not shown in the figure) is embedded into the groove 210 after being fixedly connected with the fixed part (not shown in the figure) of the first triboelectric component, so as to fixedly connect the first triboelectric component with the shell 202 and make the flow direction of the airflow in an airflow channel 205 be parallel to the plane in which the first triboelectric component is located. This arrangement is conducive to improving the driving force of the airflow on the first triboelectric component, thereby improving the vibration frequency of the first triboelectric component, and further the output voltage and sensitivity of the pneumatic sensor are improved.

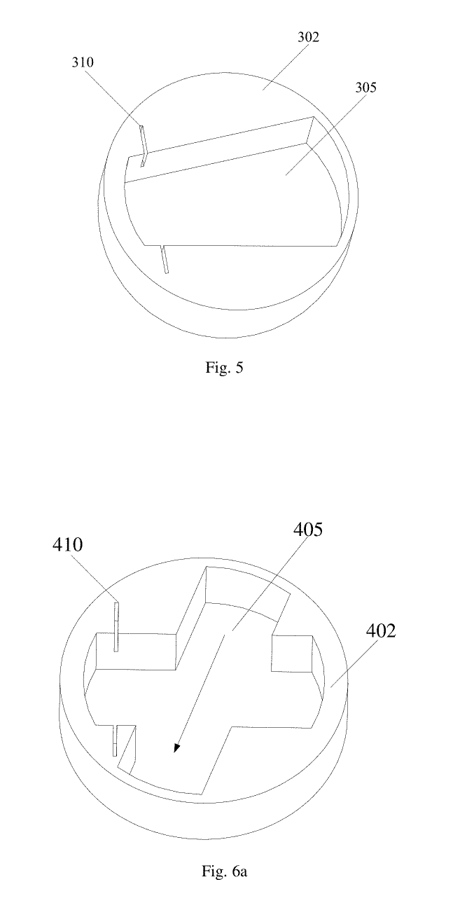

FIG. 5 is a schematic diagram of a three-dimensional structure of a shell of embodiment three of the pneumatic sensor provided by the present invention. As shown in FIG. 5, the difference between the pneumatic sensor in embodiment three and the pneumatic sensor in embodiment one lies in that the longitudinal sectional area of the side of the hollow structure close to the air intake is smaller than the longitudinal sectional area of the side of the hollow structure close to the air outlet. A groove 310 is formed in one end close to the air intake of a shell 302, and the fastener (not shown in the figure) is embedded into the groove 310 after being fixedly connected with the fixed part (not shown in the figure) of the first triboelectric component, so as to fixedly connect the first triboelectric component with the shell 302 and make the flow direction of the airflow in the airflow channel 305 be parallel to the plane in which the first triboelectric component is located. This arrangement is conducive to improving the driving force of the airflow on the first triboelectric component, thereby improving the vibration frequency of the first triboelectric component, and further the output voltage and sensitivity of the pneumatic sensor are improved.

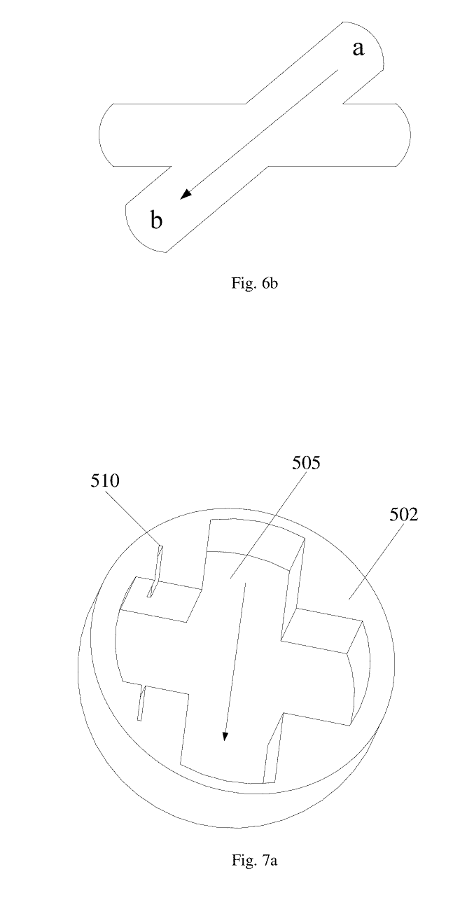

FIG. 6a is a schematic diagram of a three-dimensional structure of a shell of embodiment four of the pneumatic sensor provided by the present invention, and FIG. 6b is a schematic diagram of a cross section of a hollow structure of the shell of embodiment four of the pneumatic sensor provided by the present invention. As shown in FIG. 6a and FIG. 6b, the difference between the pneumatic sensor in embodiment four and the pneumatic sensor in embodiment one lies in that the cross section of the hollow structure is of an X-shaped structure, and the air intake and the air outlet are located at diagonal positions of the hollow structure. The fastener (not shown in the figures) is embedded into a groove 410 after being fixedly connected with the fixed part (not shown in the figures) of the first triboelectric component, so as to fixedly connect the first triboelectric component with a shell 402 and make the flow direction of the airflow in an airflow channel 405 form a preset angle with the plane in which the first triboelectric component is located. The direction pointed by an arrow is the flow direction of the airflow in the airflow channel 405. As shown in FIG. 6b, the mapping position of the air intake at the top of the shell in the cross section of the hollow structure corresponds to a position a, and the mapping position of the air outlet at the bottom of the shell in the cross section of the hollow structure corresponds to a position b. This arrangement is conducive to improving the driving force of the airflow on the first triboelectric component, thereby improving the vibration frequency of the first triboelectric component, and further the output voltage and sensitivity of the pneumatic sensor are improved.

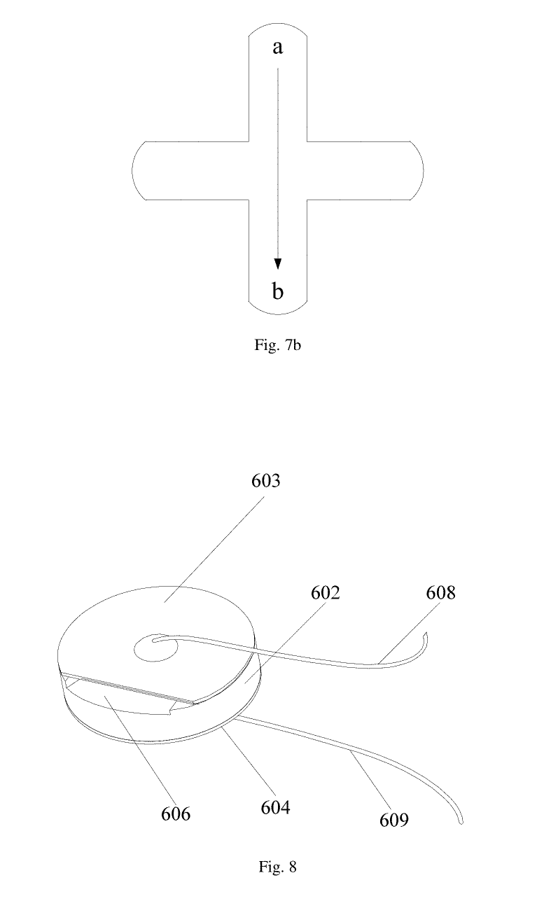

FIG. 7a is a schematic diagram of a three-dimensional structure of a shell of embodiment five of the pneumatic sensor provided by the present invention, and FIG. 7b is a schematic diagram of a cross section of a hollow structure of the shell of embodiment five of the pneumatic sensor provided by the present invention. As shown in FIG. 7a and FIG. 7b, the difference between the pneumatic sensor in embodiment five and the pneumatic sensor in embodiment one lies in that the cross section of the hollow structure is of a cross-shaped structure, and the air intake and the air outlet are located at the diagonal positions of the hollow structure. The fastener (not shown in the figures) is embedded into a groove 510 after being fixedly connected with the fixed part (not shown in the figures) of the first triboelectric component, so as to fixedly connect the first triboelectric component with a shell 502 and make the flow direction of the airflow in an airflow channel 505 be vertical to the plane in which the first triboelectric component is located. The direction pointed by an arrow is the flow direction of the airflow in the airflow channel 505. As shown in FIG. 7b, the mapping position of the air intake at the top of the shell in the cross section of the hollow structure corresponds to a position a, and the mapping position of the air outlet at the bottom of the shell in the cross section of the hollow structure corresponds to a position b. This arrangement is conducive to improving the driving force of the airflow on the first triboelectric component, thereby improving the vibration frequency of the first triboelectric component, and further the output voltage and sensitivity of the pneumatic sensor are improved.

As another optional embodiment, the arrangement of the hollow structure of the pneumatic sensor in embodiment four and embodiment five can also be changed by following the ways in embodiment two and embodiment three in such a way that the longitudinal sectional area of the side of the hollow structure close to the air intake is greater than or smaller than the longitudinal sectional area of the side of the hollow structure close to the air outlet, so as to improve the driving force of the airflow on the first triboelectric component.

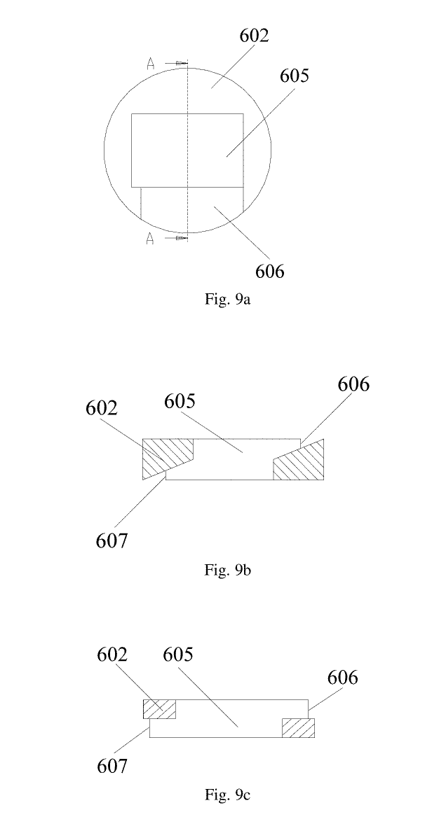

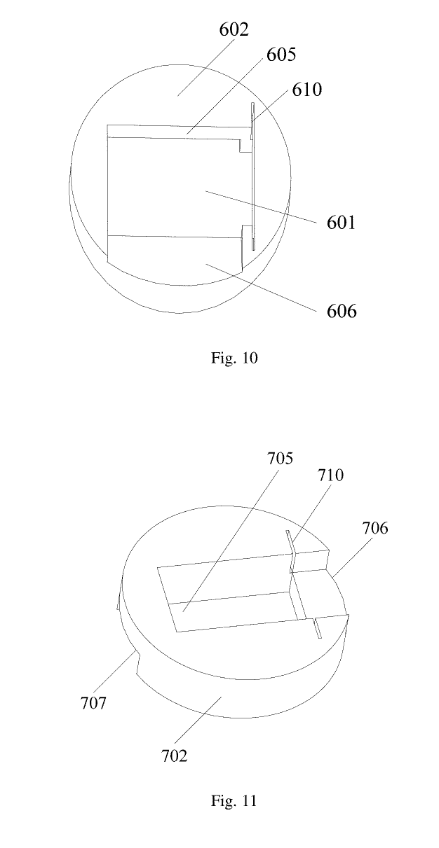

FIG. 8 is a schematic diagram of a three-dimensional structure of embodiment six of the pneumatic sensor provided by the present invention, FIG. 9a, FIG. 9b and FIG. 9c are respectively a top view, an A-A sectional view and another A-A sectional view of the shell of embodiment six of the pneumatic sensor provided by the present invention, and FIG. 10 is a schematic diagram of a three-dimensional structure after the shell and the triboelectric component are combined in embodiment six of the pneumatic sensor provided by the present invention. As shown in FIG. 8 to FIG. 10, the pneumatic sensor includes: a first triboelectric component 601, a shell 602, a first electrode 603 (i.e., a second triboelectric component) and a second electrode 604 (i.e., a third triboelectric component). The shell 602 has a hollow structure in a preset shape to form an airflow channel 605. The hollow structure is provided with an upper opening at the top of the shell 602 and a lower opening at the bottom of the shell 602, the air intake 606 is formed in a first area (the top right part of an outer wall of the shell 602 as shown in FIG. 9b or FIG. 9c) where the outer wall and the top of the shell 602 intersect, and the air outlet 607 is formed in a second area (the bottom left part of the outer wall of the shell 602 as shown in FIG. 9b or FIG. 9c) where the outer wall and the bottom of the shell 602 intersect, and the air intake 606 and the air outlet 607 are formed oppositely. The first electrode 603 partially covers the upper opening and does not cover the air intake 606; and the second electrode 604 partially covers the lower opening and does not cover the air outlet 607. The airflow channel 605 is communicated with the air intake 606 and the air outlet 607, allowing the airflow to enter the airflow channel 605 from the air intake 606 and flow out from the air outlet 607. In the embodiment, a longitudinal sectional area of the side of the hollow structure close to the air intake 606 is equal to the longitudinal sectional area of the side of the hollow structure close to the air outlet 607, and since the air intake 606 and the air outlet 607 are formed oppositely, it is conducive to improving the driving force of the airflow on the first triboelectric component 601.

The first triboelectric component 601 is arranged in the airflow channel 605. Since the first electrode 603 and the second electrode 604 partially cover the upper opening at the top and the lower opening at the bottom of the shell 602 respectively, when the airflow enters the airflow channel 605 from the air intake 606, the first triboelectric component 601 respectively forms friction with the first electrode 603 and/or the second electrode 604 due to the airflow effect, thereby generating electric signals, and the first electrode 603 and the second electrode 604 are electric signal output terminals of the pneumatic sensor. The first triboelectric component 601 of the pneumatic sensor in embodiment six is still the first triboelectric component as shown in FIG. 3. The first triboelectric component is provided with a fixed part and a triboelectric part, wherein the fixed part is fixedly connected with the shell 602, and the triboelectric part forms friction with the first electrode 603 and/or the second electrode 604.

As shown in FIG. 8, the first electrode 603 and the second electrode 604 are respectively led out by a lead wire 608 and a lead wire 609. This arrangement is conducive to processing the electric signal generated by the pneumatic sensor subsequently, of course, those skilled in the art can also use no lead wire, and this is not limited herein.

FIG. 9b and FIG. 9c show two ways of forming the air intake 606 and the air outlet 607, wherein as shown in FIG. 9b, the air intake 606 and the air outlet 607 are formed in the outer wall to form a slope surface with a certain inclination angle, while as shown in FIG. 9c, the air intake 606 and the air outlet 607 are formed in the outer wall to form a horizontal plane. In addition, the air intake 606 and the air outlet 607 are formed oppositely in FIG. 9b and FIG. 9c, and this arrangement is conducive to improving the driving force of the airflow on the first triboelectric component.

The pneumatic sensor further includes a fastener (e.g., the fastener 111 in FIG. 3), and a groove 610 is formed in the shell 602. The fastener is embedded into the groove 610 after being fixedly connected with the fixed part of the first triboelectric component 601, so as to fixedly connect the first triboelectric component 601 with the shell 602 and make the flow direction of the airflow in the airflow channel 605 be vertical to the plane in which the first triboelectric component 601 is located. This arrangement improves the driving force of the airflow on the first triboelectric component 601, thereby improving the vibration frequency of the first triboelectric component 601, and further the output voltage and sensitivity of the pneumatic sensor are effectively improved.

In addition, the first triboelectric component 601 in the embodiment includes a first high molecular polymer layer. In this case, two opposite surfaces of the first high molecular polymer layer and the first electrode 603 and two opposite surfaces of the first high molecular polymer layer and the second electrode 604 respectively constitutes triboelectric interfaces. When the airflow enters the airflow channel 605 from the air intake 606, the first high molecular polymer layer respectively forms friction with the first electrode 603 and/or the second electrode 604 under the effect of airflow, thereby generating electric signals, therefore the first high molecular polymer layer (i.e., the first triboelectric component 601), the first electrode 603 (i.e., the second triboelectric component) and the second electrode 604 (i.e., the third triboelectric component) constitute a triboelectric generator with a three-layer structure together.

In addition, in order to enhance the effect of power generation through friction, a micro-nano structure (not shown in the figures) is arranged on at least one of the two opposite surfaces in the triboelectric interfaces which are constituted by the first high molecular polymer layer with the first electrode 603 and the second electrode 604 respectively, so as to generate more inductive charges on the first electrode 603 and/or the second electrode 604.

In addition, the pneumatic sensor can further include an upper cover body (not shown in the figures) located at the top of the shell 602 and a lower cover body (not shown in the figures) located at the bottom of the shell 602. The upper cover body covers the first electrode 603, and the lower cover body covers the second electrode 604. The upper cover body and the lower cover body play a role of shielding the external interference and protecting the internal structure of the pneumatic sensor.

As another optional embodiment, the arrangement of the hollow structure of the pneumatic sensor in embodiment six can also be changed by following the ways in embodiment two and embodiment three in such a way that the longitudinal sectional area of the side of the hollow structure close to the air intake is greater than or smaller than the longitudinal sectional area of the side of the hollow structure close to the air outlet, so as to improve the driving force of the airflow on the first triboelectric component.

The difference between the pneumatic sensor in embodiment seven and the pneumatic sensor in embodiment six lies in that the flow direction of the airflow in the airflow channel is parallel to the plane in which the first triboelectric component is located. FIG. 11 is a schematic diagram of a three-dimensional structure of a shell of embodiment seven of the pneumatic sensor provided by the present invention. As shown in FIG. 11, an air intake 706 is formed in a first area (a top right part of an outer wall of a shell 702 as shown in FIG. 11) where the outer wall and the top of the shell 702 intersect, and an air outlet 707 is formed in a second area (a bottom left part of the outer wall of the shell 702 as shown in FIG. 11) where the outer wall and the bottom of the shell 702 intersect, and the air intake 706 and the air outlet 707 are formed in the outer wall to form a horizontal plane, thus allowing the airflow to flow into an airflow channel 705 from the air intake 706 and flow out from the air outlet 707.

The first triboelectric component of the pneumatic sensor in the embodiment is still the first triboelectric component as shown in FIG. 3. The fastener is embedded into a groove 710 after being fixedly connected with the fixed part of the first triboelectric component, so as to fixedly connect the first triboelectric component with the shell 702 and make the flow direction of the airflow in the airflow channel 705 be parallel to the plane in which the first triboelectric component is located. This arrangement is conducive to improving the driving force of the airflow on the first triboelectric component, thereby improving the vibration frequency of the first triboelectric component, and further the output voltage and sensitivity of the pneumatic sensor are improved.

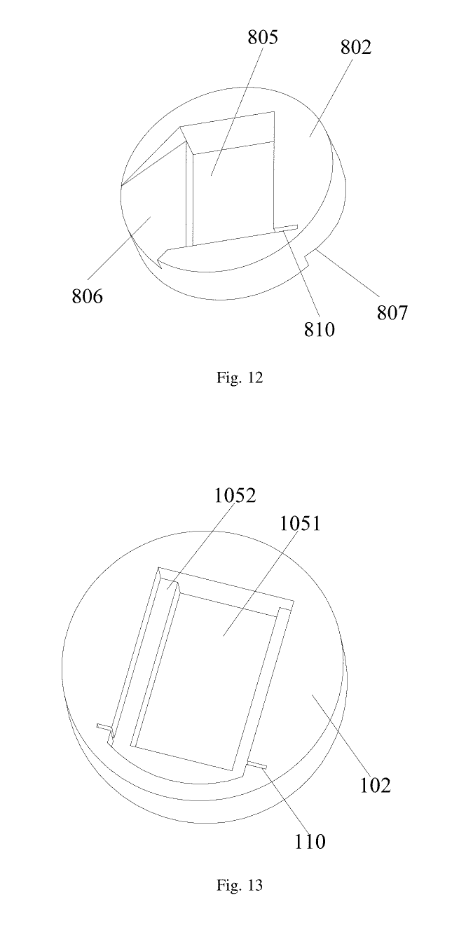

The difference between the pneumatic sensor in embodiment eight and the pneumatic sensor in embodiment six lies in that the flow direction of the airflow in the airflow channel forms a preset angle with the plane in which the first triboelectric component is located. FIG. 12 is a schematic diagram of a three-dimensional structure of a shell of embodiment eight of the pneumatic sensor provided by the present invention. As shown in FIG. 12, an air intake 806 is formed in a first area (a top left part of an outer wall of a shell 802 as shown in FIG. 12) where the outer wall and the top of the shell 802 intersect, and an air outlet 807 is formed in a second area (a bottom right part of the outer wall of the shell 802 as shown in FIG. 12) where the outer wall and the bottom of the shell 802 intersect, and the air intake 806 and the air outlet 807 are formed in the outer wall to form a slope surface with a certain inclination angle, thus allowing the airflow to flow into an airflow channel 805 from the air intake 806 and flow out from the air outlet 807.

The first triboelectric component of the pneumatic sensor in the embodiment is still the first triboelectric component as shown in FIG. 3. The fastener is embedded into a groove 810 after being fixedly connected with the fixed part of the first triboelectric component, so as to fixedly connect the first triboelectric component with the shell 802 and make the flow direction of the airflow in the airflow channel 805 form a preset angle with the plane in which the first triboelectric component is located. This arrangement is conducive to improving the driving force of the airflow on the first triboelectric component, thereby improving the vibration frequency of the first triboelectric component, and further the output voltage and sensitivity of the pneumatic sensor are improved.

For all the aforementioned embodiments, the airflow channel can include a first airflow channel and a second airflow channel. The cross sectional area of the second airflow channel is greater than the cross sectional area of the first airflow channel, and the first triboelectric component is arranged at the place where the first airflow channel and the second airflow channel intersect.

The pneumatic sensor in embodiment nine provided by the present invention is based on the pneumatic sensor in embodiment one, and the airflow channel is arranged to include the first airflow channel and the second airflow channel FIG. 13 is a schematic diagram of a three-dimensional structure of a shell of embodiment nine of the pneumatic sensor provided by the present invention. As shown in FIG. 13, the difference between the pneumatic sensor in embodiment nine and the pneumatic sensor in embodiment one lies in that the airflow channel includes a first airflow channel 1051 and a second airflow channel 1052, wherein the cross sectional area of the second airflow channel 1052 is greater than the cross sectional area of the first airflow channel 1051, and the triboelectric component is arranged at the place where the first airflow channel 1051 and the second airflow channel 1052 intersect. When the airflow enters from the air intake and flows by the first airflow channel 1051 and the second airflow channel 1052, since the flow rates of the airflow in the airflow channels with different cross sectional areas are different, the first triboelectric component vibrates in an intensified way in the airflow with two different flow rates, which further improves the vibration frequency of the first triboelectric component and improves the sensitivity of the pneumatic sensor.

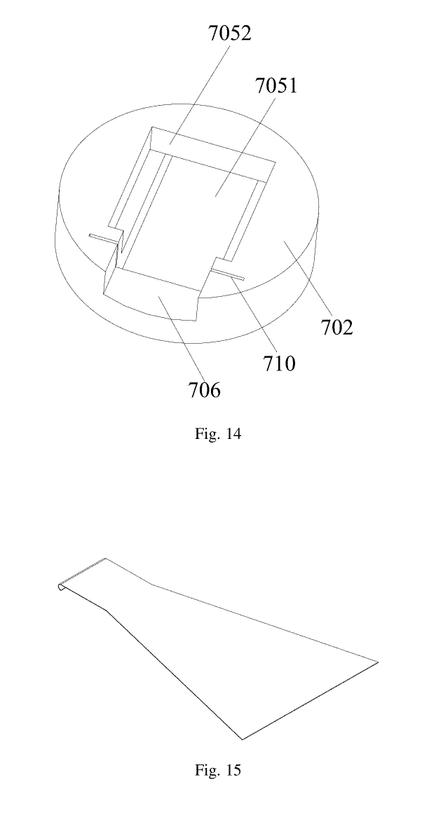

The pneumatic sensor in embodiment ten provided by the present invention is based on the pneumatic sensor in embodiment seven, and the airflow channel is arranged to include the first airflow channel and the second airflow channel FIG. 14 is a schematic diagram of a three-dimensional structure of a shell of embodiment ten of the pneumatic sensor provided by the present invention. As shown in FIG. 14, the difference between the pneumatic sensor in embodiment ten and the pneumatic sensor in embodiment seven lies in that the airflow channel includes a first airflow channel 7051 and a second airflow channel 7052, wherein the cross sectional area of the second airflow channel 7052 is greater than the cross sectional area of the first airflow channel 7051, and the triboelectric component is arranged at the place where the first airflow channel 7051 and the second airflow channel 7052 intersect. When the airflow enters from the air intake and flows by the first airflow channel 7051 and the second airflow channel 7052, since the airflow flows at different rates in the airflow channels with different cross sectional areas, the first triboelectric component vibrates in an intensified way in the airflow with two different flow rates, which further improves the vibration frequency of the first triboelectric component and improves the sensitivity of the pneumatic sensor.

As another optional embodiment, the arrangement of the hollow structure of the pneumatic sensor in embodiment seven, embodiment eight, embodiment nine and embodiment ten can also be changed by following the ways in embodiment two and embodiment three in such a way that the longitudinal sectional area of the side of the hollow structure close to the air intake is greater than or smaller than the longitudinal sectional area of the side of the hollow structure close to the air outlet, so as to enhance the driving force of the airflow on the first triboelectric component.

In all the aforementioned embodiments, the shape of the first triboelectric component can also be a trapezoid as shown in FIG. 15. Those skilled in the art can set the shape of the first triboelectric component according to actual demands, and this is not specifically defined herein in the present invention.

In all the aforementioned embodiments, the materials of the first electrode, the second electrode and the intermediate electrode can be selected from an indium tin oxide, graphene, a silver nanowire film, a metal or an alloy. The metal can be gold, silver, platinum, palladium, aluminum, nickel, copper, titanium, chromium, tin, ferrum, manganese, molybdenum, tungsten or vanadium; and the alloy can be an aluminum alloy, a titanium alloy, a magnesium alloy, a beryllium alloy, a copper alloy, a zinc alloy, a manganese alloy, a nickel alloy, a lead alloy, a tin alloy, a cadmium alloy, a bismuth alloy, an indium alloy, a gallium alloy, a tungsten alloy, a molybdenum alloy, a niobium alloy or a tantalum alloy.

In all the aforementioned embodiments, the material of the first high molecular polymer layer or the second high molecular polymer layer is respectively selected from one of a polydimethylsiloxane film, a polyimide film, a polyvinylidene fluoride film, an aniline formaldehyde resin film, a polyformaldehyde film, an ethylcellulose film, a polyamide film, a melamine formaldehyde film, a polyethylene glycol succinate film, a cellulose film, a cellulose acetate film, a polyethyleneglycol adipate film, a poly diallyl phthalate film, a fiber sponge film, a polyurethane elastomer film, a styrene-propylene copolymer film, a styrene-butadiene copolymer film, an artificial fiber film, a polymethyl film, a methacrylate film, a polyvinyl alcohol film, a polyester film, a polyisobutylene film, a flexible polyurethane sponge film, a polyethylene terephthalate film, a polyvinyl butyral film, a formaldehyde phenol film, a neoprene film, a butadiene-propylene copolymer film, a natural rubber film, a polyacrylonitrile film, an acrylonitrile vinyl chloride film and a polyethylene bisphenol carbonate film.

As another optional embodiment, in all the aforementioned embodiments, the first triboelectric component, the second triboelectric component and the third triboelectric component can also constitute a triboelectric generator with a four-layer structure or a five-layer intermediate electrode structure together, or constitute a laminated structure of a plurality of triboelectric generators.

For example, the first triboelectric component includes a first high molecular polymer layer and a second high molecular polymer layer. The second high molecular polymer layer is arranged on a surface of the first high molecular polymer layer opposite to the second electrode, and the two opposite surfaces of the first high molecular polymer layer and the first electrode, and/or the two opposite surfaces of the second high molecular polymer layer and the second electrode, and/or the two opposite surfaces of the first high molecular polymer layer and the second high molecular polymer layer constitute triboelectric interfaces. When the airflow enters the airflow channel from the air intake, the first high molecular polymer layer forms friction with the first electrode, and/or the second high molecular polymer layer forms friction with the second electrode, and/or the first high molecular polymer layer forms friction with the second high molecular polymer layer. In this way, the first high molecular polymer layer and the second high molecular polymer layer (i.e., the first triboelectric component), the first electrode (i.e., the second triboelectric component) and the second electrode (i.e., the third triboelectric component) together constitute a triboelectric generator with a four-layer structure. Moreover, in order to increase the effect of power generation through friction, a micro-nano structure can also be arranged on at least one of the two opposite surfaces constituting the triboelectric interface, so as to induce more charges on the first electrode and the second electrode. For example, the first triboelectric component includes an intermediate electrode, the second triboelectric component includes the first electrode and the first high molecular polymer layer, which are laminated in sequence, the third triboelectric component includes the second electrode and the second high molecular polymer layer, which are laminated in sequence, the two opposite surfaces of the first high molecular polymer and the intermediate electrode and/or the two opposite surfaces of the second high molecular polymer and the intermediate electrode constitute triboelectric interfaces. When the airflow enters the airflow channel from the air intake, the first high molecular polymer layer and the intermediate electrode and/or the second high molecular polymer layer and the intermediate electrode form friction, and at this time, the first electrode, the second electrode and the intermediate electrode are electric signal output terminals of the pneumatic sensor. In this way, the first triboelectric component, the second triboelectric component and the third triboelectric component together constitute a triboelectric generator with an intermediate electrode structure. Moreover, in order to increase the effect of power generation through friction, a micro-nano structure can also be arranged on at least one of the two opposite surfaces constituting the triboelectric interface, so as to induce more charges on the first electrode, the second electrode and the intermediate electrode.

In order to get a clearer and more intuitive understanding of the superior performance of the pneumatic sensor provided by the present invention, a test is carried out to contrast embodiment six to embodiment eight of the pneumatic sensor provided by the present invention with the pneumatic sensor provided with no airflow channel provided by the present invention at room temperature and room pressure.

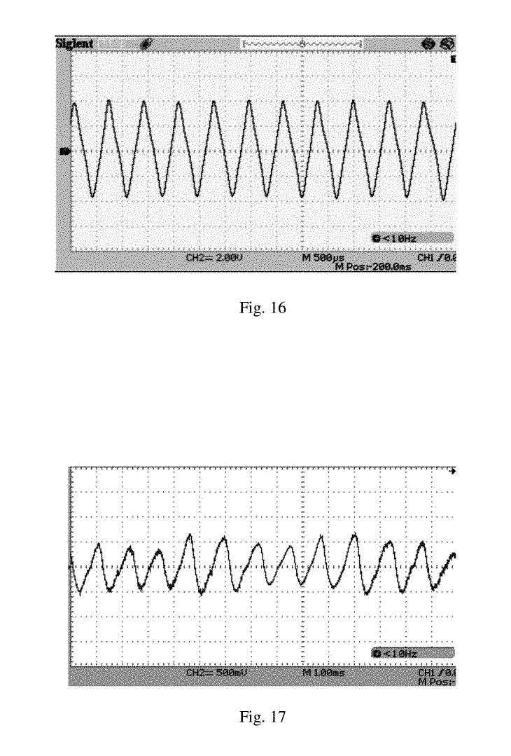

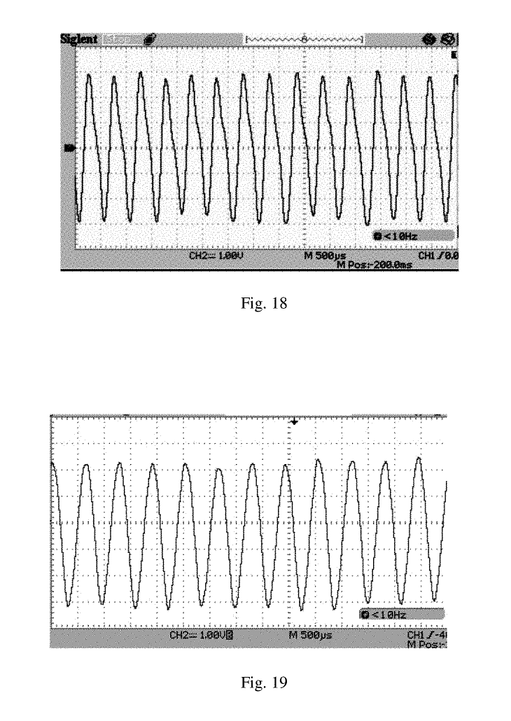

FIG. 16 is a test chart of vibration frequency of the triboelectric component of embodiment six of the pneumatic sensor provided by the present invention, and FIG. 17 is a test chart of vibration frequency of the triboelectric component of a pneumatic sensor provided with no airflow channel provided by the present invention. As shown in FIG. 16, the vibration frequency of the first triboelectric component of the pneumatic sensor in embodiment six is 1800 Hz, and the tested output voltage of the pneumatic sensor in embodiment six can reach 2.0V. As shown in FIG. 17, the vibration frequency of the triboelectric component of the pneumatic sensor provided with no airflow channel provided by the present invention is hundreds of hertz, and the tested output voltage of the pneumatic sensor is generally several hundreds of millivolts.

Therefore, the pneumatic sensor in embodiment six provided by the present invention can effectively improve the vibration frequency of the first triboelectric component and can improve the output voltage of the pneumatic sensor. In addition, compared with the pneumatic sensor provided with no airflow channel provided by the present invention, the output voltage of the pneumatic sensor in embodiment six is more stable.

FIG. 18 is a test chart of vibration frequency of the triboelectric component of embodiment seven of the pneumatic sensor provided by the present invention. As shown in FIG. 18, the vibration frequency of the triboelectric component of the pneumatic sensor in embodiment seven is 2000 Hz, in addition, the tested output voltage of the pneumatic sensor in embodiment seven can reach 3.0V. FIG. 19 is a test chart of vibration frequency of the triboelectric component of embodiment eight of the pneumatic sensor provided by the present invention. As shown in FIG. 18, the vibration frequency of the triboelectric component of the pneumatic sensor in embodiment eight is 1400 Hz, in addition, the tested output voltage of the pneumatic sensor in embodiment eight can reach 3.0V. Moreover, it is found in the test that when the airflow is larger, the output voltage of the pneumatic sensor in embodiment eight can reach 7-8V. As can be seen, the pneumatic sensor in embodiment seven and embodiment eight provided by the present invention can effectively improve the vibration frequency of the first triboelectric component and can improve the output voltage of the pneumatic sensor. In addition, compared with the pneumatic sensor provided with no airflow channel provided by the present invention, the output voltage of the pneumatic sensor in embodiment two and embodiment three is more stable.

In addition, the vibration frequency of the first triboelectric component and the magnitude of the output voltage of the pneumatic sensor provided by the present invention have a close relationship with the width of the airflow channel, and the thickness, the width and the length of the first triboelectric component and the like. Those skilled in the art can properly change the aforementioned technical parameters according to different demands to change the vibration frequency of the triboelectric component and the magnitude of the output voltage of the pneumatic sensor.

According to the technical solutions provided by the present invention, the airflow channel is formed inside the shell, the first triboelectric component is arranged in the airflow channel, and when the airflow enters the airflow channel from the air intake, the first triboelectric component forms friction with the second triboelectric component and/or the third triboelectric component due to the airflow effect, thereby generating electric signals. The aforementioned pneumatic sensor provided by the present invention simplifies the manufacturing process of the pneumatic sensors and improves the driving force of the airflow on the first triboelectric component in the pneumatic sensor, therefore the vibration frequency of the first triboelectric component is improved, and further the output voltage, the sensitivity and the stability of the pneumatic sensor are effectively improved.

The totally enclosed triboelectric generator constituted by the first triboelectric component, the second triboelectric component and the third triboelectric component includes vibrating film which surrounds to form an enclosed hollow cavity and a fixed film located inside the enclosed hollow cavity; the vibrating film forms contact friction with the fixed film under the action of an external force to form a triboelectric interface; the vibrating film is provided with a first electrode layer and/or a second electrode layer; and the first electrode layer and/or the second electrode layer serve(s) as an electric signal output terminals of the totally enclosed triboelectric generator.

The vibrating film comprises a first vibrating film and a second vibrating film, and the end parts of the first vibrating film and the second vibrating film are adhered with each other to form the enclosed hollow cavity; in addition, the vibrating film can also be of an integrated structure.

The totally enclosed triboelectric generator can use the first electrode layer and the second electrode layer as the electric signal output terminals thereof; meanwhile, any one of its electrode layers and any end of an external circuit which can form a potential difference with the triboelectric generator can also be used as the electric signal output terminals of the totally enclosed triboelectric generator, and this is not limited herein.

The structure and the working principle of the totally enclosed triboelectric generator provided by the present invention will be further introduced below by specific embodiments.

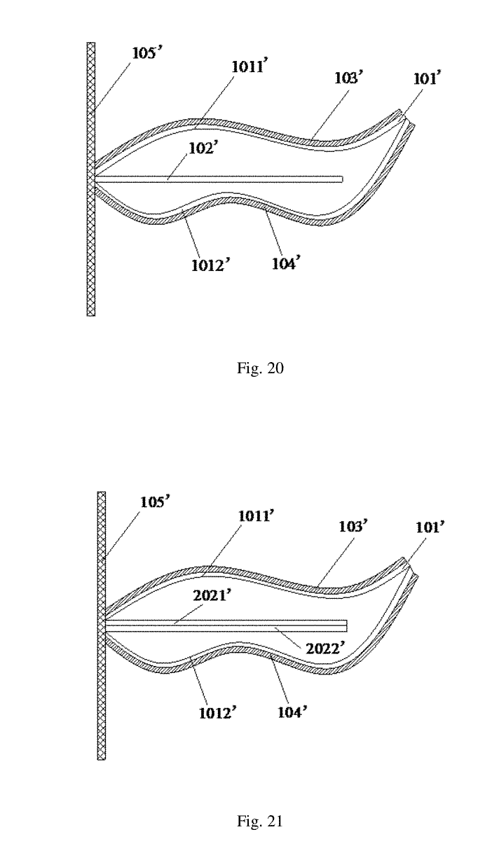

FIG. 20 shows a schematic diagram of a totally enclosed triboelectric generator provided by an embodiment of the present invention. As shown in FIG. 20, the totally enclosed triboelectric generator includes vibrating film 101′ which surrounds to form an enclosed hollow cavity and a fixed film 102′ located inside the enclosed hollow cavity; the vibrating film 101′ forms contact friction with the fixed film 102′ under the action of an external force to form a triboelectric interface; the vibrating film 101′ is provided with a first electrode layer 103′ and a second electrode layer 104′ on its outer side surface, and the first electrode layer 103′ and the second electrode layer 104′ are not in contact with each other; and the first electrode layer 103′ and/or the second electrode layer 104′ serve(s) as an electric signal output terminals of the totally enclosed triboelectric generator.

In the embodiment, the vibrating film 101′ is composed of a first vibrating film 1011′ and a second vibrating film 1012′, and the end parts of the first vibrating film 1011′ and the second vibrating film 1012′ are adhered with each other to form the enclosed hollow cavity, wherein the distance from the first vibrating film 1011′ to the fixed film 102′ can be equal to or not equal to the distance from the second vibrating film 1012′ to the fixed film 102′, however, in order to increase the potential difference between the first electrode layer 103′ and the second electrode layer 104′ when the first electrode layer 103′ and the second electrode layer 104′ are respectively used as the electric signal output terminals of the totally enclosed triboelectric generator, preferably, the distance from the first vibrating film 1011′ to the fixed film 102′ is different from the distance from the second vibrating film 1012′ to the fixed film 102′. In the embodiment, both the vibrating film 101′ and the fixed film 102′ are made of a high molecular polymer material, wherein the materials of the first vibrating film 1011′, the second vibrating film 1012′ and the fixed film 102′ can be the same or different, or the materials of any two of the films are the same, those skilled in the art can make a choice according to demands, and this is not defined herein; in order to increase the effect of power generation through friction, the first vibrating film 1011′ and the second vibrating film 1012′ respectively form contact friction with the fixed film 102′ to generate more charges, therefore to make the first electrode layer 103′ and the second electrode layer 104′ induce more charges, and preferably, the materials of the first vibrating film 1011′, the second vibrating film 1012′ and the fixed film 102′ are different.

In addition, a supporting component 105′ is further arranged at the outside of the enclosed hollow cavity, the vibrating film 101′ and the fixed film 102′ are both fixed on the supporting component 105′, wherein the supporting component 105′ can be an acrylic rod, a glass rod, a stainless steel rod, a ceramic rod or an alloy rod, and can also be a rod made of a hard high molecular polymer material or other rods having mechanical rigid supporting functions, and this is not defined herein.

The working principle of the totally enclosed triboelectric generator provided by the embodiment is as follows: when the vibrating film 101′ is exerted with an external force, the first vibrating film 1011′ forms mutual friction with the fixed film 102′, and the second vibrating film 1012′ forms mutual friction with the fixed film 102′ to produce charges, resulting in a potential difference between the first electrode layer 103′ and the second electrode layer 104′. Due to the potential difference between the first electrode layer 103′ and the second electrode layer 104′, free electrons will flow from one side with low potential to one side with high potential via an external circuit, so as to form current in the external circuit; when the vibrating film 101′ recovers to its original state, an internal potential formed between the first electrode layer 103′ and the second electrode layer 104′ disappears, a reverse potential difference will be generated again between the first electrode layer 103′ and the second electrode layer 104′, which have been balanced at this time, then the free electrons form reverse current through the external circuit, and thus an alternating current signal is formed in the external circuit. Since the distances from the first vibrating film 1011′ and the second vibrating film 1012′ to the fixed film 102′ are different, unequal charges are induced on the first electrode layer 103′ and the second electrode layer 104′, resulting in an increased potential difference between the first electrode layer 103′ and the second electrode layer 104′, and the effect of power generation through friction is improved.

FIG. 21 shows a schematic diagram of a totally enclosed triboelectric generator provided by another embodiment of the present invention. The difference of the embodiment as shown in FIG. 21 with the embodiment as shown in FIG. 20 lies in that the fixed film includes two high molecular polymer layers (which are respectively a first high molecular polymer layer and a second high molecular polymer layer). As shown in FIG. 21, the fixed film includes a first high molecular polymer layer 2021′ and a second high molecular polymer layer 2022′. Specifically, when the vibrating film 101′ is exerted with the external force, the first vibrating film 1011′ forms contact friction with the first high molecular polymer layer 2021′, and the second vibrating film 1012′ forms contact friction with the second high molecular polymer layer 2022′ to form triboelectric interfaces, so as to respectively induce charges on the first electrode layer 103′ and the second electrode layer 104′ to generate a potential difference between the first electrode layer 103′ and the second electrode layer 104′. The materials of the first vibrating film 1011′, the second vibrating film 1012′, the first high molecular polymer layer 2021′ and the second high molecular polymer layer 2022′ can be the same or different, or the materials of any two or three of the films are the same, those skilled in the art can make a choice according to demands, and this is not defined herein; in order to increase the effect of power generation through friction, the first vibrating film 1011′ forms contact friction with the first high molecular polymer layer 2021′ and the second vibrating film 1012′ forms contact friction with the second high molecular polymer layer 2022′ to generate more charges, therefore to make the first electrode layer 103′ and the second electrode layer 104′ induce more charges, and preferably, the first high molecular polymer layer 2021′ and the second high molecular polymer layer 2022′ are made of different materials. In another optional embodiment, the vibrating films in the embodiments as shown in

FIG. 20 and FIG. 21 can also be of an integrated structure, the first electrode layer and the second electrode layer are formed on the outer side surface of the vibrating film, and the first electrode layer and the second electrode layer are not in contact with each other. Specifically, when the vibrating film is exerted with the external force, the vibrating film and the fixed film form mutual friction to produce charges, and charges are respectively induced on the first electrode layer and the second electrode layer to generate a potential difference between the first electrode layer and the second electrode layer.

In addition, when the fixed film includes multiple high molecular polymer layers, the materials of the multiple high molecular polymer layers can be the same or different, or the materials of any two of the films are the same, those skilled in the art can make a choice according to demands, and this is not defined herein; in order to increase the effect of power generation through friction, preferably, the two high molecular polymer layers forming the triboelectric interface are made of different materials.

Further, in all the aforementioned embodiments, the first electrode layer and the second electrode layer can be formed on an inner side surface of the vibrating film, and the first electrode layer and the second electrode layer are not in contact with each other. Specifically, when the vibrating film is exerted with the external force, the first electrode layer forms contact friction with the fixed film, and the second electrode layer forms contact friction with the fixed film to form triboelectric interfaces, so as to generate a potential difference between the first electrode layer and the second electrode layer. More specifically, when the fixed film includes multiple high molecular polymer layers, in order to increase the effect of power generation through friction, preferably, the two high molecular polymer layers forming the triboelectric interface are made of different materials.

Further, in all the aforementioned embodiments, the first electrode layer can be formed on the inner side surface of the vibrating film, the second electrode layer can be formed on the outer side surface of the vibrating film, and the first electrode layer and the second electrode layer are not in contact with each other. Specifically, when the vibrating film is exerted with the external force, the first electrode layer forms contact friction with the fixed film, and the vibrating film forms contact friction with the fixed film to form triboelectric interfaces, so as to generate a potential difference between the first electrode layer and the second electrode layer. In addition, the first electrode layer can also be formed on the outer side surface of the vibrating film, the second electrode layer can be formed on the inner side surface of the vibrating film, and when the vibrating film is exerted with an external force, the vibrating film forms contact friction with the fixed film, and the second electrode layer forms contact friction with the fixed film to form triboelectric interfaces, so as to generate the potential difference between the first electrode layer and the second electrode layer.

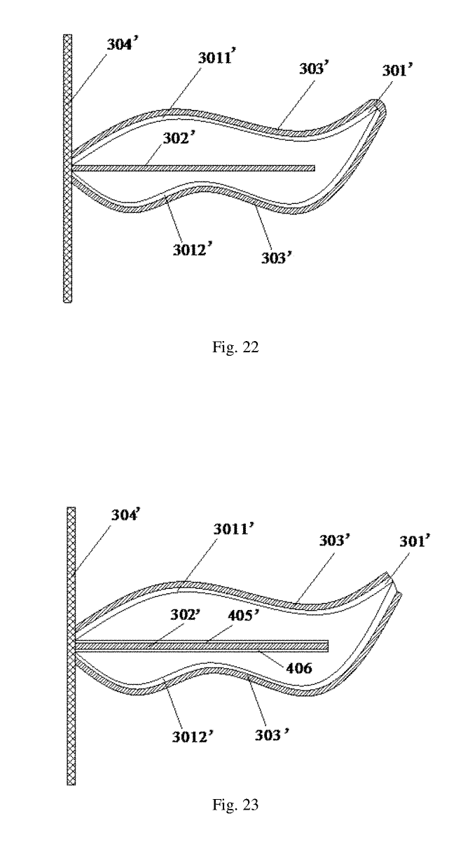

FIG. 22 shows a schematic diagram of a totally enclosed triboelectric generator provided by yet another embodiment of the present invention. As shown in FIG. 22, the totally enclosed triboelectric generator includes vibrating film 301′ which surrounds to form an enclosed hollow cavity and a fixed film located inside the enclosed hollow cavity; the vibrating film 301′ forms contact friction with the fixed film under the action of an external force to form a triboelectric interface, wherein the fixed film is a first electrode layer 302′, a second electrode layer 303′ is formed on an outer side surface of the vibrating film 301′, and the first electrode layer 302′ and the second electrode layer 303′ are not in contact with each other; and the first electrode layer 302′ and/or the second electrode layer 303′ are/is an electric signal output terminal(s) of the totally enclosed triboelectric generator.

In the embodiment, the vibrating film 301′ is composed of a first vibrating film 3011′ and a second vibrating film 3012′, and the end parts of the first vibrating film 3011′ and the second vibrating film 3012′ are adhered with each other to form an enclosed hollow cavity. The distance from the first vibrating film 3011′ to the fixed film can be equal to or not equal to the distance from the second vibrating film 3012′ to the fixed film, however, in order to increase the potential difference between the first electrode layer 302′ and the second electrode layer 303′ when the first electrode layer 302′ and the second electrode layer 303′ are respectively used as the electric signal output terminals of the totally enclosed triboelectric generator, preferably, the distance from the first vibrating film 3011′ to the fixed film is different from the distance from the second vibrating film 3012′ to the fixed film.

The materials of the first vibrating film 3011′ and the second vibrating film 3012′ can be the same or different, those skilled in the art can make a choice according to demands, and this is not defined herein; in order to increase the effect of power generation through friction, the first vibrating film 3011′ and the second vibrating film 3012′ respectively form contact friction with the fixed film to generate more charges, therefore make the first electrode layer 302′ and the second electrode layer 303′ induce more charges, and preferably, the first vibrating film 3011′ and the second vibrating film 3012′ are made of different materials.

In the embodiment, the second electrode layer 303′ is an electrode layer of an integrated structure, and it is completely coated on the outer side surface of the vibrating film 301′. In this way, the second electrode layer 303′ can not only be used as the electric signal output terminal of the totally enclosed triboelectric generator, but also can be used as a shielding layer of the totally enclosed triboelectric generator to play a role of self-shielding, so as to prevent the interference of external electric signals, simplify the manufacturing process and reduce costs. Of course, the second electrode layer 303′ can also be divided into a plurality of parts, which are respectively arranged on the outer side surface of the vibrating film 301′. For example, the second electrode layer 303′ is divided into two parts, which are respectively arranged on the outer side surfaces of the first vibrating film 3011′ and the second vibrating film 3012′.

In addition, a supporting component 304′ is further arranged at the outside of the enclosed hollow cavity, the vibrating film 301′ and the fixed film are fixed on the supporting component 304′, wherein the supporting component 304′ can be an acrylic rod, a glass rod, a stainless steel rod, a ceramic rod or an alloy rod, and can also be a rod made of a hard high molecular polymer material or other rods having mechanical rigid supporting functions, and this is not defined herein.

The working principle of the totally enclosed triboelectric generator provided by the embodiment is as follows: when the vibrating film 301′ is exerted with an external force, the first vibrating film 3011′ forms mutual friction with the first electrode layer 302′, and the second vibrating film 3012′ forms mutual friction with the first electrode layer 302′ to produce charges, resulting in a potential difference between the first electrode layer 302′ and the second electrode layer 303′. Due to the potential difference between the first electrode layer 302′ and the second electrode layer 303′, free electrons will flow from one side with low potential to one side with high potential via an external circuit, so as to form current in the external circuit; when the vibrating film 301′ recovers to its original state, an internal potential formed between the first electrode layer 302′ and the second electrode layer 303′ disappears, a reverse potential difference will be generated again between the first electrode layer 302′ and the second electrode layer 303′, which have been balanced at this time, then the free electrons form reverse current through the external circuit, and thus an alternating current signal is formed in the external circuit. As the distances from the first vibrating film 3011′ and the second vibrating film 3012′ to the fixed film are different, unequal charges are induced on the first electrode layer 302′ and the second electrode layer 303′, resulting in an increased potential difference between the first electrode layer 302′ and the second electrode layer 303′, and the effect of power generation through friction is improved.

In another optional embodiment, the second electrode layer can also be arranged on the inner side surface of the vibrating film, but it must be guaranteed that the first electrode layer and the second electrode layer are not in contact with each other. Specifically, when the vibrating film is exerted with an external force, the first electrode layer and the vibrating film form mutual friction to form the triboelectric interface, so as to generate a potential difference between the first electrode layer and the second electrode layer.

FIG. 23 shows a schematic diagram of a totally enclosed triboelectric generator provided by yet another embodiment of the present invention. As shown in FIG. 23, the totally enclosed triboelectric generator includes vibrating film 301′ which surrounds to form an enclosed hollow cavity and a fixed film located inside the enclosed hollow cavity; the fixed film includes a first high molecular polymer layer 405′, a first electrode layer 302′ and a second high molecular polymer layer 406′, which are laminated in sequence; a second electrode layer 303′ is formed on an outer side surface of the vibrating film 301′, and the first electrode layer 302′ and the second electrode layer 303′ are not in contact with each other; the vibrating film 301′ forms contact friction with the fixed film under the action of an external force to form a triboelectric interface; that is to say, the first high molecular polymer layer 405′ forms contact friction with a first vibrating film 3011′ to form a triboelectric interface, and the second high molecular polymer layer 406′ forms contact friction with a second vibrating film 3012′ to form a triboelectric interface; and in order to increase the effect of power generation through friction, the first high molecular polymer layer 405′ and the second high molecular polymer layer 406′ are made of different materials.

In the embodiment, the vibrating film 301′ is composed of the first vibrating film 3011′ and the second vibrating film 3012′, and the end parts of the first vibrating film 3011′ and the second vibrating film 3012′ are adhered with each other to form the hollow cavity. The distance from the first vibrating film 3011′ to the fixed film can be equal to or different from the distance from the second vibrating film 3012′ to the fixed film, however, in order to increase the potential difference between the first electrode layer 302′ and the second electrode layer 303′ when the first electrode layer 302′ and the second electrode layer 303′ are respectively used as the electric signal output terminals of the totally enclosed triboelectric generator, preferably, the distance from the first vibrating film 3011′ to the fixed film is different from the distance from the second vibrating film 3012′ to the fixed film.

The second electrode layer 303′ can be divided into a plurality of parts, which are respectively arranged on the outer side surface of the vibrating film 301′. Specifically, in the embodiment, the second electrode layer 303′ is divided into two parts, which are respectively arranged on the outer side surfaces of the first vibrating film 3011′ and the second vibrating film 3012′. Of course, the second electrode layer 303′ can also be an electrode layer of an integrated structure, and it is completely coated on the outer side surface of the vibrating film 301′. Since the second electrode layer 303′ is arranged in this way, the second electrode layer 303′ can not only be used as the electric signal output terminal of the totally enclosed triboelectric generator, but also can be used as a shielding layer of the totally enclosed triboelectric generator to play a role of self-shielding, so as to prevent the interference of external electric signals, simplify the manufacturing process and reduce costs.

In addition, a supporting component 304′ is further arranged at the outside of the enclosed hollow cavity, the vibrating film 301′ and the fixed film are fixed on the supporting component 304′, wherein the supporting component 304′ can be an acrylic rod, a glass rod, a stainless steel rod, a ceramic rod or an alloy rod, and can also be a rod made of a hard high molecular polymer material or other rods having mechanical rigid supporting functions, and this is not defined herein.

The working principle of the totally enclosed triboelectric generator provided by the embodiment is as follows: when the vibrating film 301′ is exerted with an external force, the first vibrating film 3011′ forms mutual friction with the first high molecular polymer layer 405′, and the second vibrating film 3012′ forms mutual friction with the second high molecular polymer layer 406′ to produce charges, resulting in a potential difference between the first electrode layer 302′ and the second electrode layer 303′.

Due to the potential difference between the first electrode layer 302′ and the second electrode layer 303′, free electrons will flow from one side with low potential to one side with high potential via an external circuit, so as to form current in the external circuit; when the vibrating film 301′ recovers to its original state, the internal potential formed between the first electrode layer 302′ and the second electrode layer 303′ disappears, a reverse potential difference will be generated again between the first electrode layer 302′ and the second electrode layer 303′, which have been balanced at this time, then the free electrons form reverse current through the external circuit, therefore, an alternating current signal is formed in the external circuit. Since the distance from the first vibrating film 3011′ to the first high molecular polymer layer 405′ is different from the distance from the second vibrating film 3012′ to the second high molecular polymer layer 406′, unequal charges are induced on the first electrode layer 302′ and the second electrode layer 303′, resulting in an increased potential difference between the first electrode layer 302′ and the second electrode layer 303′, and the effect of power generation through friction is improved.

It should be noted that, in the embodiment, the second electrode layer 303′ can also be arranged on the inner side surface of the vibrating film, the first electrode layer 302′ and the second electrode layer 303′ are not in contact with each other, in this case, the first high molecular polymer layer 405′ forms contact friction with the second electrode layer 303′ and the second high molecular polymer layer 406′ forms contact friction with the second electrode layer 303′ to form the triboelectric interfaces.

Further, the vibrating film in the aforementioned embodiment can also be of an integrated structure.

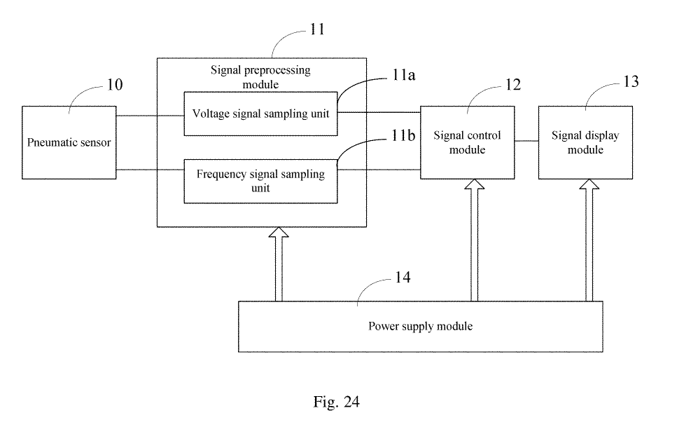

FIG. 24 shows a functional block diagram of an embodiment of a signal processing system included in the pneumatic sensor provided by the present invention. As shown in FIG. 24, the signal processing system includes a signal preprocessing module 11 and a signal control module 12.

The signal preprocessing module 11 is connected with an electric signal output terminal of the pneumatic sensor 10 and is used for collecting an output signal of the pneumatic sensor 10 and acquiring a flag bit signal according to the result obtained by comparing the output signal with a preset threshold. The signal preprocessing module 11 samples the output signal in view of the features of the output signals of the pneumatic sensor 10. The pneumatic sensor is generally with a small output current but a large output voltage, therefore it can sample the output signal depending on the voltage signal.

Specifically, the signal preprocessing module 11 includes a voltage signal sampling unit 11a, which is used for collecting the output signal of the pneumatic sensor 10, comparing a voltage of the output signal with a preset voltage threshold, and acquiring a low level flag bit signal if the voltage of the output signal is lower than the preset voltage threshold; and acquiring a high level flag bit signal if the voltage of the output signal is higher than or equal to the preset voltage threshold. For example, if the preset voltage threshold is 100 mV, and the voltage of the output signal is lower than the value, then the low level flag bit signal is output; and if the voltage of the output signal is higher than or equal to the value, the high level flag bit signal is output.

Optionally, the output signal can also be sampled by frequency selection. Specifically, the signal preprocessing module 11 can include a frequency signal sampling unit 11b, used for collecting the output signal of the pneumatic sensor 10, comparing the frequency of the output signal with a preset frequency range, and acquiring a high level flag bit signal if the frequency of the output signal falls into the preset frequency range; and acquiring a low level flag bit signal if the frequency of the output signal does not fall into the preset frequency range.

To further improve the accuracy and stability of the signal processing system, voltage sampling and frequency sampling can be adopted at the same time. That is, the signal preprocessing module 11 simultaneously includes the voltage signal sampling unit 11a and the frequency signal sampling unit 11b, the voltage signal sampling unit 11a is used for comparing the voltage of the output signal with the preset voltage threshold, and the frequency signal sampling unit 11b is used for comparing the frequency of the output signal with the preset frequency range. If the voltage of the output signal is higher than or equal to the preset voltage threshold and the frequency of the output signal falls into the preset frequency range, the high level flag bit signal is acquired; and if the voltage of the output signal is lower than the preset voltage threshold and/or the frequency of the output signal does not fall into the preset frequency range, the low level flag bit signal is acquired. Specifically, if the voltage of the output signal is lower than the preset voltage threshold and the frequency of the output signal falls into the preset frequency range, or if the voltage of the output signal is higher than or equal to the preset voltage threshold and the frequency of the output signal does not fall into the preset frequency range, or the voltage of the output signal is lower than the preset voltage threshold and the frequency of the output signal does not fall into the preset frequency range, the low level flag bit signal is acquired. Due to the simultaneous voltage sampling and frequency sampling, the accuracy of the entire signal processing system is improved, the false alarm rate is lowered, and the stability of the entire system is improved.

The signal control module 12 is used for receiving the flag bit signal output by the signal preprocessing module 11 and analyzing and processing the flag bit signal to acquire a trigger working signal. In the present invention, the signal control module 12 analyzes and processes the flag bit signal and acquires the trigger working signal when analyzing to acquire that the flag bit signal is the high level flag bit signal, and the trigger working signal is used for triggering a subsequent working program to work. With an electronic cigarette as an example, the trigger working signal output by the signal control module 12 is used for triggering the atomizer of the electronic cigarette to work, so as to volatilize the tobacco tar nearby to generate smoke for the user to inhale.

Further, to improve the accuracy and stability of the system, when it is analyzed that the flag bit signal is the high level flag bit signal, the trigger working signal is further acquired according to the duration of the high level flag bit signal. If the duration of the high level flag bit signal is too short, for example, an instantaneous high level, then the trigger working signal does not need to be output.

The signal processing system provided by the present invention can further include a signal display module 13, and the signal display module 13 is connected with the signal control module 12 and is used for displaying the working state of the pneumatic sensor according to the trigger working signal. The signal display module 13 can be an LED lamp or a display screen. When the magnitudes of the signals output by the pneumatic sensor are different, the signal display module 13 can display according to an analysis result of the signal control module 12 and intuitively feedback the working state to the user. In addition, the signal display module 13 can also display whether a voltage sampling mode, or a frequency sampling mode or a voltage and frequency sampling mode is applied to the output signal.

The signal processing system provided by the present invention can further include a power supply module 14, used for supplying power to the signal preprocessing module 11, the signal control module 12 and the signal display module 13. The power supply module 14 can be a lithium battery or a rechargeable charging module, and the charging mode can be USB charging, Bluetooth wireless charging, etc.

According to the integration manner of the power supply module, the aforementioned modules for collecting, analyzing and processing the signal in the present invention can be integrated into a one-piece structure or a discrete structure.

The one-piece structure is a chip based on the application-specific integrated circuit (ASIC) technology, and the signal preprocessing module, the signal control module, the signal display module and the power supply module are integrated into one chip. Compared with general-purpose integrated circuits, it has the advantages of smaller volume, lighter weight, lower power consumption, higher reliability, enhanced performance, enhanced security, and lower cost, etc.

The discrete structure collects, analyzes and processes the signal through a Micro Control Unit, that is, the signal preprocessing module and the signal control module are integrated into the Micro Control Unit, and the entire signal processing system is realized by an external power supply module.

The aforementioned pneumatic sensor provided by the present invention can be used in an electronic cigarette. The electronic cigarette includes: a smoke pipe body and a cigarette holder, wherein the cigarette holder is arranged at one end of the smoke pipe body; a pneumatic sensor, being arranged inside the smoke pipe body; and a battery component, a control circuit board and an atomizer; an air intake hole, being formed in the smoke pipe body; the battery component supplies power to the control circuit board and the atomizer, and the control circuit board is connected with the signal processing system and the atomizer; the pneumatic sensor is located in a ventilation channel which is communicated with the air intake hole and the cigarette holder. When the airflow enters the ventilation channel through the air intake hole, the output signal is generated due to the airflow effect, the trigger working signal is output to the control circuit board after being processed by the signal processing system, and the control circuit board controls the atomizer to work according to the trigger working signal.

It should be noted that the aforementioned signal processing system can also be used in other systems which generate similar signals as the pneumatic sensor, and it is not limited to the application in the electronic cigarette.

The signal processing system designed for the signals of the pneumatic sensor and provided by the present invention collects, analyzes and processes tiny signals output by the pneumatic sensor, so that the output trigger working signal is more accurate and stable.

Finally, it should be noted that merely specific embodiments of the present invention are listed above, of course, those skilled in the art can make modifications and variations to the present invention, and if these modifications and variations fall into the scope of the claims of the present invention and the equivalent technology thereof, they are deemed as falling within the protection scope of the present invention.

1. A pneumatic sensor, having an air intake and an air outlet, wherein the pneumatic sensor comprises a first triboelectric component, a shell, a second triboelectric component and a third triboelectric component, wherein,
the shell has a hollow structure in a preset shape to form an airflow channel, and the airflow channel is communicated with the air intake and the air outlet, thus allowing the airflow to enter the airflow channel from the air intake and flow out from the air outlet;
the first triboelectric component is arranged in the airflow channel, and the second triboelectric component and the third triboelectric component are arranged at positions capable of contacting with the first triboelectric component; and
when the airflow enters the airflow channel from the air intake, the first triboelectric component respectively forms friction with the second triboelectric component and/or the third triboelectric component due to the airflow effect, thereby generating electric signals, and the second triboelectric component and the third triboelectric component comprise electric signal output terminals of the pneumatic sensor.

2. The pneumatic sensor of claim 1, wherein the hollow structure is provided with an upper opening at the top of the shell and a lower opening at the bottom of the shell; and
the second triboelectric component partially covers the upper opening to form the air intake, and the third triboelectric component partially covers the lower opening to form the air outlet.

3. The pneumatic sensor of claim 1, wherein the hollow structure is provided with an upper opening at the top of the shell and a lower opening at the bottom of the shell;
the air intake is formed in a first area where an outer wall and the top of the shell intersect, and the air outlet is formed in a second area where the outer wall and the bottom of the shell intersect; and
the second triboelectric component partially covers the upper opening and does not cover the air intake; and the third triboelectric component partially covers the lower opening and does not cover the air outlet.

4. The pneumatic sensor of claim 1, further comprising an upper cover body located at the top of the shell and a lower cover body located at the bottom of the shell; the upper cover body covers the second triboelectric component; and the lower cover body covers the third triboelectric component.

5. The pneumatic sensor of claim 1, wherein the first triboelectric component is provided with a fixed part and a triboelectric part; the fixed part is fixedly connected with the shell; and the triboelectric part forms friction with the second triboelectric component and/or the third triboelectric component.

6. The pneumatic sensor of claim 5, further comprising a fastener, wherein a groove is formed in the shell; and the fastener is embedded into the groove after being fixedly connected with the fixed part of the first triboelectric component.

7. The pneumatic sensor of claim 1, wherein the flow direction of the airflow in the airflow channel is parallel to, vertical to or forms a preset angle with the plane in which the first triboelectric component is located.

8. The pneumatic sensor of claim 7, wherein the longitudinal sectional area of the side of the hollow structure close to the air intake is greater than the longitudinal sectional area of the side of the hollow structure close to the air outlet.

9. The pneumatic sensor of claim 7, wherein the longitudinal sectional area of the side of the hollow structure close to the air intake is smaller than the longitudinal sectional area of the side of the hollow structure close to the air outlet.

10. The pneumatic sensor of claim 7, wherein the cross section of the hollow structure is of a structure shaped like “—”, and the air intake and the air outlet are respectively located at the top and the bottom of the two ends of the hollow structure.

11. The pneumatic sensor of claim 7, wherein the cross section of the hollow structure is of an X-shaped structure, and the air intake and the air outlet are respectively located at diagonal positions of the hollow structure.

12. The pneumatic sensor of claim 7, wherein the cross section of the hollow structure is of a cross-shaped structure, and the air intake and the air outlet are respectively located at the diagonal positions of the hollow structure.

13. The pneumatic sensor of claim 1, wherein the airflow channel comprises a first airflow channel and a second airflow channel; the cross sectional area of the second airflow channel is greater than the cross sectional area of the first airflow channel; and the first triboelectric component is arranged at the place where the first airflow channel and the second airflow channel intersect.

14. The pneumatic sensor of claim 1, wherein the first triboelectric component comprises a first high molecular polymer layer; the second triboelectric component comprises a first electrode; and the third triboelectric component comprises a second electrode; and
when the airflow enters the airflow channel from the air intake, the first high molecular polymer layer forms friction with the first electrode and/or the second electrode; the two opposite surfaces of the first high molecular polymer layer and the first electrode and/or the two opposite surfaces of the first high molecular polymer layer and the second electrode constitute triboelectric interfaces; and the first electrode and the second electrode are electric signal output terminals of the pneumatic sensor.

15. The pneumatic sensor of claim 14, wherein the first triboelectric component further comprises a second high molecular polymer layer; the second high molecular polymer layer is arranged on a surface of the first high molecular polymer layer opposite to the second electrode; and the two opposite surfaces of the first high molecular polymer layer and the first electrode, and/or the two opposite surfaces of the second high molecular polymer layer and the second electrode, and/or the two opposite surfaces of the first high molecular polymer layer and the second high molecular polymer layer constitute triboelectric interfaces; and when the airflow enters the airflow channel from the air intake, the first high molecular polymer layer and the first electrode, and/or the second high molecular polymer layer and the second electrode, and/or the first high molecular polymer layer and the second high molecular polymer layer form friction.

16. The pneumatic sensor of claim 1, wherein the first triboelectric component comprises an intermediate electrode; the second triboelectric component comprises the first electrode and the first high molecular polymer layer which are laminated in sequence; the third triboelectric component comprises the second electrode and the second high molecular polymer layer which are laminated in sequence; and the two opposite surfaces of the first high molecular polymer layer and the intermediate electrode and/or the two opposite surfaces of the second high molecular polymer layer and the intermediate electrode constitute triboelectric interfaces; and when the airflow enters the airflow channel from the air intake, the first high molecular polymer layer and the intermediate electrode and/or the second high molecular polymer layer and the intermediate electrode form friction; and the first electrode, the second electrode and the intermediate electrode are electric signal output terminals of the pneumatic sensor.

17. The pneumatic sensor of claim 14, wherein a micro-nano structure is arranged on at least one of the two opposite surfaces constituting the triboelectric interface.

18. The pneumatic sensor of claim 14, wherein the material of the first high molecular polymer layer or the second high molecular polymer layer is selected from one of a polydimethylsiloxane film, a polyimide film, a polyvinylidene fluoride film, an aniline formaldehyde resin film, a polyformaldehyde film, an ethylcellulose film, a polyamide film, a melamine formaldehyde film, a polyethylene glycol succinate film, a cellulose film, a cellulose acetate film, a polyethyleneglycol adipate film, a poly diallyl phthalate film, a fiber sponge film, a polyurethane elastomer film, a styrene-propylene copolymer film, a styrene-butadiene copolymer film, an artificial fiber film, a polymethyl film, a methacrylate film, a polyvinyl alcohol film, a polyester film, a polyisobutylene film, a flexible polyurethane sponge film, a polyethylene terephthalate film, a polyvinyl butyral film, a formaldehyde phenol film, a neoprene film, a butadiene-propylene copolymer film, a natural rubber film, a polyacrylonitrile film, an acrylonitrile vinyl chloride film and a polyethylene bisphenol carbonate film.

19. The pneumatic sensor of claim 1, wherein,
the first triboelectric component, the second triboelectric component and the third triboelectric component constitute a totally enclosed triboelectric generator;
the second triboelectric component and the third triboelectric component are jointly configured as vibrating film which surrounds to form an enclosed hollow cavity, and the first triboelectric component is configured as a fixed film located inside the enclosed hollow cavity; the vibrating film forms contact friction with the fixed film under the action of an external force to form a triboelectric interface;
the vibrating film is provided with a first electrode layer and/or a second electrode layer; and
the first electrode layer and/or the second electrode layer serve(s) as an output terminal(s) of the totally enclosed triboelectric generator.

20. The pneumatic sensor of claim 19, wherein the vibrating film is composed of a first vibrating film and a second vibrating film, and end parts of the first vibrating film and the second vibrating film are adhered with each other to form the enclosed hollow cavity; or, the vibrating film is of an integrated structure.

21. The pneumatic sensor of claim 20, wherein the fixed film comprises at least one high molecular polymer layer which is laminated;
the first electrode layer and the second electrode layer are formed on one side surface of the vibrating film, and the first electrode layer and the second electrode layer are not in contact with each other;
the at least one high molecular polymer layer respectively forms contact friction with the first electrode layer and the second electrode layer to form triboelectric interfaces; or
the at least one high molecular polymer layer respectively forms contact friction with the vibrating film to form the triboelectric interface.

22. The pneumatic sensor of claim 20, wherein the fixed film comprises the first electrode layer;
the second electrode layer is formed on one side surface of the vibrating film, and the first electrode layer and the second electrode layer are not in contact with each other; and
the first electrode layer respectively forms contact friction with the vibrating film or the second electrode layer to form the triboelectric interface.

23. The pneumatic sensor of claim 20, wherein the fixed film comprises the first high molecular polymer layer, the first electrode layer and the second high molecular polymer layer, which are laminated in sequence;
the second electrode layer is formed on one side surface of the vibrating film, and the first electrode layer and the second electrode layer are not in contact with each other; and
the first high molecular polymer layer forms contact friction with the vibrating film or the second electrode layer, or the second high molecular polymer layer forms contact friction with the vibrating film or the second electrode layer to form triboelectric interfaces.

24. The pneumatic sensor of claim 20, further comprising: a supporting component located at the outside of the hollow cavity, wherein the fixed film and the vibrating film are all fixed on the supporting component.

25. The pneumatic sensor of claim 1, further comprising a signal processing system, wherein the signal processing system comprises a signal preprocessing module connected with the electric signal output terminals of the pneumatic sensor and a signal control module connected with the signal preprocessing module;
the signal preprocessing module is used for collecting an output signal of the pneumatic sensor and acquiring a flag bit signal according to the result obtained by comparing the output signal with a preset threshold; and
the signal control module is used for receiving the flag bit signal output by the signal preprocessing module and analyzing and processing the flag bit signal to acquire a trigger working signal.

26. The pneumatic sensor of claim 25, wherein the signal preprocessing module comprises: a voltage signal sampling unit, used for collecting the output signal of the pneumatic sensor, comparing the voltage of the output signal with a preset voltage threshold, and acquiring a low level flag bit signal if the voltage of the output signal is lower than the preset voltage threshold; and acquiring a high level flag bit signal if the voltage of the output signal is higher than or equal to the preset voltage threshold.

27. The pneumatic sensor of claim 25, wherein the signal preprocessing module comprises: a frequency signal sampling unit, used for collecting the output signal of the pneumatic sensor, comparing the frequency of the output signal with a preset frequency range, and acquiring a low level flag bit signal if the frequency of the output signal does not fall into the preset frequency range; and acquiring a high level flag bit signal if the frequency of the output signal falls into the preset frequency range.

28. The pneumatic sensor of claim 25, wherein the signal preprocessing module comprises: a voltage signal sampling unit used for comparing the voltage of the output signal with a preset voltage threshold and a frequency signal sampling unit used for comparing the frequency of the output signal with a preset frequency range;
if the voltage of the output signal is higher than or equal to the preset voltage threshold and the frequency of the output signal falls into the preset frequency range, a high level flag bit signal is acquired; and
if the voltage of the output signal is lower than the preset voltage threshold and/or the frequency of the output signal does not fall into the preset frequency range, a low level flag bit signal is acquired.

29. The pneumatic sensor of claim 26, wherein the signal control module is specifically used for acquiring the trigger working signal according to the duration of the high level flag bit signal when analyzing to acquire that the flag bit signal is the high level flag bit signal.

30. The pneumatic sensor of claim 25, further comprising: a signal display module connected with the signal control module; and
the signal display module is used for displaying the working state of the pneumatic sensor according to the trigger working signal.

31. The pneumatic sensor of claim 29, further comprising: a signal display module connected with the signal control module; and
the signal display module is used for displaying the working state of the pneumatic sensor according to the trigger working signal.

32. The pneumatic sensor of claim 25, further comprising: a power supply module, used for supplying power to the signal preprocessing module and the signal control module.

33. The pneumatic sensor of claim 32, wherein the power supply module is integrated into a one-piece structure or a discrete structure together with the signal preprocessing module and the signal control module.

34. An electronic cigarette, comprising the pneumatic sensor of claim 1.
